(19) United States
(12) Patent Application Publication
(10) Pub. No.: US 2003/0108453 A1
(43) Pub. Date: Jun. 12, 2003

(54) Block for maintenance, calibration and validation of automated multiplex analytical systems

(75) Inventors: Quan Nguyen, Pleasant Hill, CA (US); Diana Davis, Sacramento, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Inc., Hercules, CA (US)

(21) Appl. No.: 10/012,190

(22) Filed: Dec. 7, 2001

(51) Int. Cl. B01L 3/14

(52) U.S. Cl. 422/102

(57) ABSTRACT

Various functions for maintenance, calibration and validation of an automated instrument that is capable of performing multiple simultaneous assays using fluorescence detection and microscopic beads as a solid phase are provided by a single block that is inserted into the instrument in place of a sample plate. The block contains several different sets of wells, all appropriately labeled, for the retention of various liquids and bead suspensions, including different sets for the different functions.

### BACKGROUND OF THE INVENTION

The pharmaceutical and biotechnology industry is continually seeking to produce new drugs, to find new applications for existing drugs or drugs that have failed screening tests or clinical trials, and to accelerate and lower the cost of the drug discovery process. These efforts make extensive use of bioassays, particularly in drug discovery, genetic analysis, pharmacogenomics, clinical diagnostics, and general biomedical research to detect the presence or status of certain biochemicals, proteins or genes in a biological sample. The global market for assay materials and instrumentation to develop and perform bioassays for the drug discovery and development market alone is estimated to be on the order of $8 billion, and is projected to continue to grow at an annual rate of 14%.

One of the most active areas of development in bioassay technology is high-throughput screening. Efforts to modify, expand and improve high throughput screening have resulted in the emergence of a variety of screening systems, techniques and instrumentation. Examples of these systems are described in U.S. Pat. No. 6,280,618, entitled “Multiplex Flow Assays Preferably with Magnetic Particles as Solid Phase,” Watkins et al., inventors, Bio-Rad Laboratories, Inc., assignee, issued Aug. 28, 2001. One commercial example of such a system is the Bio-Plex Protein Array System of Bio-Rad Laboratories, Inc., of Hercules, Calif., USA. The Bio-Plex system is a highly multiplexed fluorescent reading system with the capability of reading up to 100 assays per well in 96-well Microtiter plates. The system uses microscopic beads as a solid phase and a flow-based dual laser detector system with real-time digital signal processing to distinguish up to 100 different families of color-coded, monodisperse beads. Due to the complexity of the system and its use of precision flow channels and optical components, it is important that the system be checked regularly for proper operation to make sure that all optical components are in alignment and operational and that all fluid channels are open and properly functioning, and that the detection components are properly calibrated over the full range of intensities to provide accurate, reproducible, and reliable results. When problems arise, it is important to be able to distinguish between those that are due to instrument malfunction, those that are due to inadequacies or limitations of the assays, and those that are due to operator error.

### SUMMARY OF THE INVENTION

The present invention resides in a single block for performing maintenance, calibration and validation of automated high-throughput assay instrumentation. The typical instrument on which the block will be used is one that is designed to perform multiple simultaneous assays on samples that are held in sample plates of standardized dimensions. The instrument has a fluorescence-based detection system that includes two or more optical excitation lasers of different wavelengths, fluorescence detectors, and a flow cytometry cell, together with a fluidics system which includes liquid transfer components and conduits for manipulation of the contents of the wells of the sample plates in order to perform the assay protocols. The assays are performed in two-phase liquid-solid media with microscopic beads serving as the solid phase. Quantitative assay results are obtained by measuring fluorescence intensity of certain fluorophores on the assay materials, and the various assays are differentiated from each other by colored classification labels on the microscopic beads, each color being a different combination of two or more base colors that can be differentiated by the detection system on the basis of the proportions used in each combination. The maintenance/calibration/validation block of the present invention is shaped to be inserted into the instrument in place of a standardized sample plate, while the various functions performed on the block are controlled by user-directed software associated with the instrument.

The maintenance function of the block serves to assure fluidics integrity within the instrumentation, i.e., to assure that the fluid flow channels in the instrument are free from contamination by previous samples, and that they are clear of any flow-restricting debris so that they will permit unobstructed flow. The block thus contains wells to accommodate appropriate decontamination and cleaning fluids and marked with appropriate indicia to guide the user in placing these fluids in the wells. The calibration function of the block is used for adjusting the individual fluorescence detectors for optimal detection of the base colors whose combinations are used to differentiate among the various assays. The block thus contains a separate set of wells to retain microscopic beads of each base color, each well in the set marked with indicia to guide the user in placing calibration beads into the appropriate wells.

The validation function of the block is threefold: first, to check that the light transmission channels are optically aligned with the flow cytometry cell to assure that light from the excitation lasers is properly focused on the cell; second, to check that the assay signals emitted from the cell are detectable by the fluorescence detectors over the anticipated range of intensity; and third, to check the classification efficiency of the detection system, i.e., the ability of the system to differentiate between assays by distinguishing between different proportions of the base colors. Each of the three validation functions is served by a separate subset of wells labeled with appropriate indicia to guide the user in placing the different beads in the appropriate wells.

These and other features and advantages of the block, its use, and the details of various specific embodiments of the concepts of this invention are set forth below.

### BRIEF DESCRIPTION OF THE DRAWINGS

FIG. 1 is a plan view of a maintenance/calibration/validation block in accordance with this invention.

### DETAILED DESCRIPTION OF THE INVENTION AND PREFERRED EMBODIMENTS

To perform its maintenance function, the block contains separate wells for cleaning and/or decontamination agents. An example of what can be placed in these wells is deionized water in one well, a 70% aqueous isopropanol solution in another, and a 10% aqueous bleach solution in a third. The instrument can be directed by the maintenance software to purge the fluid transmission lines with these liquids in a designated sequence, and then to aspirate calibration beads into the lines and measure the bead flow rate through the lines to determine if any obstructions remain. The flow rate may be measured in terms of events per microliter, and an example of a flow rate that indicates the absence of obstructions is one that is greater than 100 events per microliter. The maintenance function can be performed routinely to qualify the instrument prior to operation and to diagnose fluidics problems that arise during operation.

For the calibration function, the number of different base colors involved can be as little as two, and preferred blocks in accordance with the invention contain only two calibration wells, one designated for each of the two base colors. As an example, one color may be red and the other orange, and red and orange calibration beads may be supplied with the block. Each bead will have the dye of the appropriate color stably embedded in the bulk of the bead. The instrument can then be directed by the maintenance software to detect the beads in the two wells separately by the two fluorescence detectors that are focused on the two colors, and to adjust the detectors if necessary so that they detect the respective base colors at optimum wavelengths that distinguish one color from the other.

The optical alignment check involves separate wells in the block for irradiation by the separate excitation lasers. The wells are labeled accordingly, and in instruments for which the block is preferably used, there are two separate excitation lasers and the block contains separately labeled wells for each one. Special optics beads, specifically designed for this purpose, are preferably supplied.

The purpose of checking the assay signals is to validate the reporter channel of the instrument, which is the fluorescence channel used for assay quantitation. The performance parameters of the channel are dynamic range, linearity, accuracy of reporter channel response, sensitivity, and slope of the response. The dynamic range is the calculated number of decades covered by the log amplifier from the slope and the histogram scale. The range for the Bio-Plex system referenced above is 4.5 log amp decades or 32,767 relative linear channels. Linearity is determined by a plot of the reporter channel median fluorescence intensity values vs. the corresponding assigned MESF values, and is expressed as the coefficient of determination. Typically, this value must be greater than 0.995. The accuracy of the reporter channel response is the percent difference that the regression line is away from the actual MESF value data points. Typically, the desired value is greater than 90%.

A single dye is typically used as the primary reporter molecule in the assays. One example of such a dye is R-phycoerythrin. To assure that the reporter channel provides proper quantitation, a series of beads dyed with varying intensities of a fluorochrome that is spectrally matched to the reporter molecule is used. Each subset of beads is assigned a specific intensity value corresponding to a particular number of fluorescent reporter molecules on the bead surface. Typically, the block will contain a blank well and wells for at least three fluorescence intensities. The units of measurement can be termed “molecules of equivalent soluble fluorescence” (MESF). The slope of the reporter line resulting from the plotting of reporter channel fluorescence values against assigned MESF values of the beads is a measure of the dynamic range of the instrument and an indication of the response of the photomultiplier tube.

The checking of the classification efficiency of the detection system addresses the ability of the system to discriminate between assay beads that are impregnated with different types, combinations, or quantities of fluorescent dyes since these differences are used to distinguish one assay from another, particularly among assays that are all included in a single well of the sample plate. The Bio-Plex system referred to above, for example uses two fluorescent dyes at varying ratios among the various assay beads, and the different levels and ratios of these dyes can produce as many as 100 sets of beads that are differentiable from each other by the fluorescence detectors. Typically, the block will accommodate at least three different combinations (ratios). For optimal results, a classification efficiency of greater than 80% is generally required. The block of the present invention is provided with a set of wells specifically designated for the validation of this aspect of the operation. Several such wells are included, each representing a different region of the classification array. In the Bio-Plex example, individual wells may for example represent different values of the two-dye combination, differing in ratio, amount, or both.

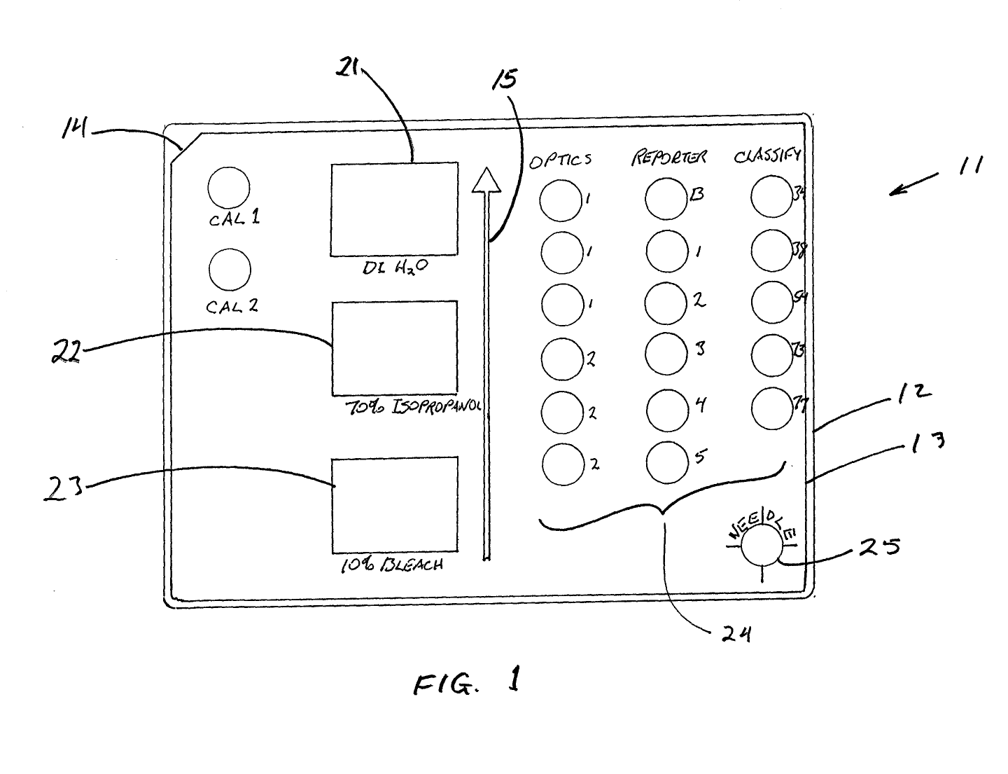

FIG. 1 illustrates one example of a maintenance/calibration/validation block 11 embodying the features of this invention. The block is designed for the Bio-Plex system referenced above and has the external dimensions (length, width, and thickness) of a standard 96-well Microtiter plate, including a rectangular flange 12 with rounded corners and a raised central section 13 with an angle-cut corner 14 to assure proper orientation. The block fits into openings, trays or holders that are designed for Microtiter plates, and an arrow 15 printed on the top surface of the block serves as a guide to the user for insertion of the block in the proper orientation.

The wells in the block do not correspond to the wells of a Microtiter plate, but are instead arranged according to their function. Access to the wells is governed by software associated with the instrument itself. Of the various wells included in the block, the maintenance function is served by three rectangular wells 21, 22, 23, labeled for deionized water, 70% isopropanol, and bleach, respectively. The calibration function of the block is served by two calibration wells, labeled “CAL 1” and “CAL 2” respectively for each of the two base colors in the fluorescence detection system. The validation function is served by three sets of wells (collectively numbered 24 in the drawing), labeled “OPTICS,” “REPORTER,” and “CLASSIFY,” respectively. The “OPTICS” wells include three wells labeled “1” and three labeled “2” representing the two excitation lasers. In normal operation, only one of the wells labeled “1” and one of the wells labeled “2” are used. The “REPORTER” wells are six in number, including a well labeled “B” to designate blank (undyed) beads and five wells numbered “1” through “5,” each of the five designating one decade of a 4.5-decade log scale of fluorescence intensity. The “CLASSIFY” wells are five in number, with numbers indicating five different regions in the 100-level classification range. Also included on the block is a well marked “NEEDLE” 25 which is used for alignment of the tubular probes used to draw fluids from, and discharge fluid into, the wells.

The block shown in the drawing will be supplied with sets of specially designated beads of 5-micron diameter in aqueous suspensions at concentrations of about 1×10⁵ beads/mL. The beads are embedded with appropriate fluorescent dyes selected for each of the various functions. Software that performs the various functions and directs the user through the various preparation and monitoring steps is readily available and adaptable by those skilled in the art.

The foregoing is offered primarily for purposes of illustration. Further variations, modifications, and substitutions that still embody the concepts of the invention will be readily apparent to those skilled in the art.

What is claimed is:

1. A block for maintenance, calibration and validation of an automated instrument, said instrument comprising a fluorescence-based detection system comprising a plurality of wavelength-differentiated optical excitation lasers, a plurality of wavelength-differentiated fluorescence detectors, and a flow cytometry cell, and means for drawing liquid from and discharging liquid into multi-well sample plates of standardized external dimensions, said instrument capable of performing a plurality of assays on samples retained in said sample plates and using fluorescent to simultaneously detect and differentiate from each other the results of said assays, said block having the same size and external dimensions as said sample plates and said block having formed therein:
a set of maintenance wells labeled with indicia indicating liquid cleaning media for cleaning fluid flow channels in said instrumentation;
a set of calibration wells each of which is labeled with indicia indicating a fluorescent dye corresponding to one of said fluorescence detectors; and
a set of validation wells comprising the following three subsets of wells:
(i) a subset of optical alignment wells labeled with indicia separately indicating fluorescent dyes excitable by each of said optical excitation lasers;
(ii) a subset of reporter wells labeled with indicia separately indicating a plurality of fluorescence intensities; and
(iii) a subset of classification wells labeled with indicia separately indicating a plurality of fluorescent dye combinations differentiable by said detection system.

2. A block in accordance with claim 1 in which said plurality of wavelength-differentiated optical excitation lasers consists of two such lasers and said plurality of wavelength-differentiated fluorescence detectors consists of two such detectors, and said set of calibration sells consists of two such calibration wells.

3. A block in accordance with claim 1 in which said set of maintenance wells consists of three wells labeled with indicia indicating deionized water, isopropanol, and bleach, respectively.

4. A block in accordance with claim 1 in which said subset of reporter wells comprises one well labeled with indicia indicating use of said well as a blank and a plurality of wells labeled with indicia indicating at least three different fluorescence intensities.

5. A block in accordance with claim 1 in which said subset of classification wells comprise at least three wells labeled with indicia indicating at least three distinct combinations of two fluorescent dyes.
